(19) United States
(12) Patent Application Publication
(10) Pub. No.: US 2012/0098652 A1
(43) Pub. Date: Apr. 26, 2012

(54) Bright OnBoard Display

(76) Inventors: David J. Varella, West Palm Beach, FL (US); Jay Robert Widows, Lantana, FL (US)

(21) Appl. No.: 12/912,294

(22) Filed: Oct. 26, 2010

(51) Int. Cl. B60Q 1/00

(52) U.S. Cl. 340/425.5

(57) ABSTRACT

The present invention, Bright OnBoard Display and Control System, relates to a communication system, and more specifically to a message display unit. Bright Onboard Display and Control System utilizes illumination technology configured to display preset or user programmable text messages and graphics. The onboard display can be rectangular-shaped LCD, LED, or other illumination technology. A control system is coupled to the onboard display. The control system is designed so that it allows for simultaneously transmitting (sending and receiving) messages through social websites and other existing messaging platforms to the onboard display.

### BACKGROUND OF THE INVENTION

1. Field of the Invention

The present invention, Bright OnBoard Display and Control System, relates to a communication system, and more specifically to a message display unit. The Bright Onboard Display and Control System utilizes illumination technology configured to display preset or user programmable text messages and graphics. The onboard display can be rectangular-shaped LCD, LED, or other illumination technology. A control system is coupled to the onboard display. The control system is designed so that it allows for simultaneously transmitting (sending and receiving) messages through social websites and other existing messaging platforms to the onboard display.

2. Description of Related Art

Advancement in technology has led to the advertisement industry in switching static boards to dynamic electronic screens including illumination technologies. One of the advantages of dynamic electronic screens is affordable advertising. Illumination technologies message center costs less per month than any other major advertising media. It allows marketers to change their messages whenever they like, allowing marketers to sell more than one thing.

Currently, illumination technologies are also used to display preset and user programmable text message and graphics. The message could consist of scrolling, blinking, or otherwise animated text and incorporate simple graphics. It is capable of continuously displaying multiple messages or could be timer controlled to grab the attention of whoever comes into sight with it. The mobility of the device that easily attaches to the back window allows cars to become mobile billboards and the platforms to communicate messages. At a time when public have become increasingly mobile and increasingly overloaded with information, it is the most powerful way to reach a mass audience efficiently. Vehicle message display board becomes a powerful platform for people to share their messages and thoughts as is in a bumper sticker in the past.

Furthermore, because illumination technologies are easily viewable in sunlight or in the dark, they have been used with vehicles to display messages for the purposes of major problem notifications and traffic/driving related communications. Illumination technologies (e.g. LED and LCD) for providing onboard message display is known in the prior art. Numerous vehicular message display systems exist in the prior art, such as the inventions disclosed in U.S. Pat. Nos. 4,688,343; 5,218,629; 7,259,691; 7,642,730; 7,477,140, and U.S. PreGrant document 2009/0256697.

More specifically, by way of example, U.S. Pat. No. 5,825,281 discloses a vehicular messaging display for advertisement. A message to be displayed is sent to the display device from an onboard processor, having been retrieved from memory. The message comes on with the automotive brake lights and remains on until the brakes are released. The message changes with each application of the brake lights and is a continuous loop of sequentially displayed messages.

More specifically, by way of example, U.S. Pat. No. 7,659,808 discloses a vehicular messages display unit that allows one of a plurality of messages to be displayed on at least one of the front or rear windshield to other drivers. A remote control unit is provided for customizing messages by the user in terms of content and appearance as well as for controlling the display of the messages.

United States Patent Application 2003/0227375 discloses an automotive vehicle courtesy messages display system that allows the driver of an automotive vehicle to visually display courtesy messages to the drivers of vehicles located to the rear. Such messages may be for an occasional urgent request to “cut in” for safe passage. The system includes a wireless control unit located on the vehicle operator's steering wheel and transmits an appropriate message to the display screen (generally in the rear of the car) depending on the particular touch sensor depressed.

In an era where social media is an emerging trend, the present invention sees the importance of social sharing and incorporates this concept like no other inventions out there. No prior art in the field (vehicular message display) has features that allow simultaneous transmitting (sending and receiving) messages through social websites and other existing messaging platforms to the onboard display.

### SUMMARY OF THE INVENTION

In an exemplary embodiment of the present invention, there is disclosed a Bright Onboard Display and Control System, which relates to a message display unit that can be used in the car, boats, and bicycles, etc.

The Bright Onboard Display and Control System utilizes illumination technology configured to display a preset or user programmable text message and graphics. The onboard display can be rectangular shaped LCD, LED, or other illumination technology. A control system is coupled to the onboard display through wireless communication technologies, which may include but not limited to RF, Bluetooth, IR, or the combination thereof.

The apparatus (i.e. Bright OnBoard Display and Control System) further comprises a remote control with a setup menu incorporating numerous options such as color, personal information, set up option; it is capable of storing up to 1000 messages. The control system is able to associate digit numbers 1, 2, 3 onwards to preset messages. The remote control and the control system may have microphones.

The control system having a speech recognition system that recognizes voice commands that triggers corresponding preset messages to display on the onboard display. Moreover, the speech recognition system may have the capacity to convert voice message/phrase received through a microphone to text, in real time, to display on the onboard display. This will allow a phrase to be entered in without pre-programming.

The apparatus also has wireless capabilities built in. The apparatus is able to utilize current messaging platforms (such as IM), social web sites, and a designated web site such as “BrightOnboardDisplay.com” to provide a platform for sending and receiving messages. Moreover, as a user sends a message to the onboard display, it could simultaneously be sent to one or more email addresses or web sites.

The control system can be incorporated into the original electronic system of the vehicle by auto manufacturer or it could be sold as a standalone component with dash mount. Besides vehicles, the apparatus could also be used with bicycles, boats, etc.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a front view of an embodiment of the Bright OnBoard Display with the LED illumination means.

FIG. 2 is a front view of the Bright OnBoard Display control system mounted on the dashboard of a car and the remote control with an integrated microphone.

FIG. 3 is a front view of the Bright OnBoard Display control system incorporated into the original electronic system of a car. The system is in the form of a touch screen interface built into the dash in conjunction with other electronic devices such as GPS and/or multimedia player.

FIG. 4 is a front view of the Bright OnBoard Display installed in the rear window of a car.

FIG. 5 illustrates the capabilities of an embodiment of the Bright Onboard Display control system viewed from the front.

### DESCRIPTION OF THE PREFERRED EMBODIMENT

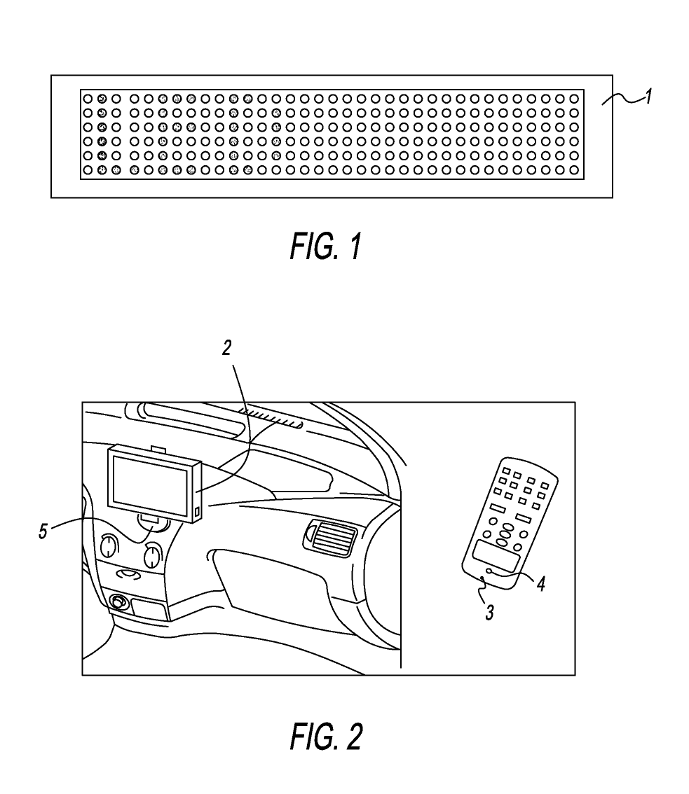

Referring to FIG. 1, there is disclosed a Bright Onboard Display 1 and control system 2 utilizing illumination technology configured to display a preset or user programmable text message and graphics. The onboard display 1 can be rectangular-shaped LCD, LED, or other illumination technology. A control system 2 is coupled to the onboard display through wireless communication technologies, which may include but are not limited to Bluetooth 6, IR 7, RF 8 or the combination thereof.

FIG. 2 illustrates one embodiment further comprising a remote control 3 with a setup menu incorporating numerous options such as color (e.g. single color, multicolor, or random), personal information (e.g. name, address number, any medical conditions), set up option (e.g. animation speed, auto shutoff timer). The control system 2 is capable of storing up to 1000 messages and is able to associate digit numbers 1, 2, 3 onwards to preset messages. The remote control 3 also has a microphone 4.

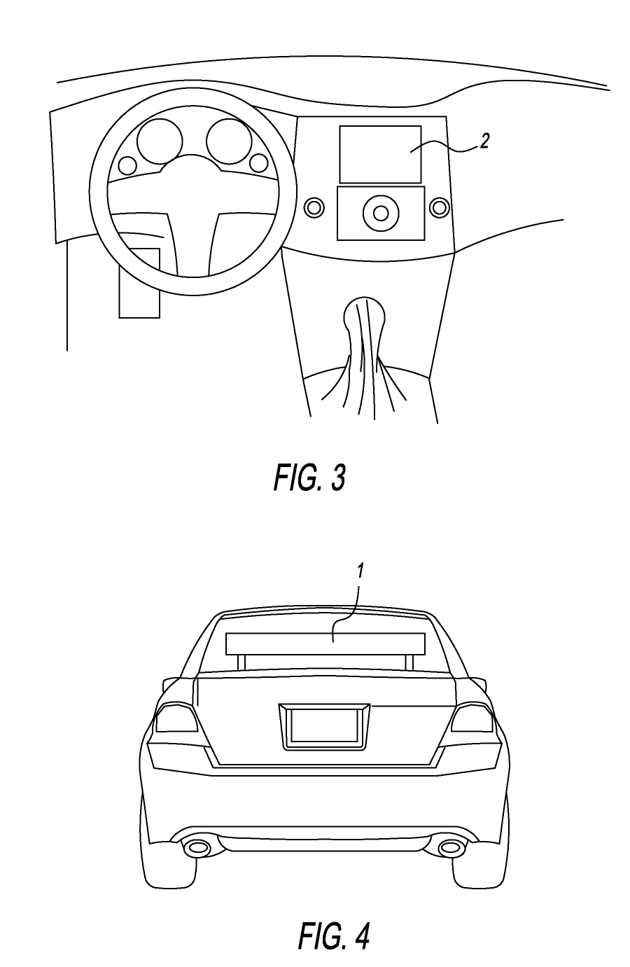

FIG. 3 illustrates the control system 2 being incorporated into the original electronic system of the vehicle by auto manufacturer. The system can be in the form of a touch screen 13 interface built into the dash. This could be done in conjunction with other electronic devices such as GPS 14 and/or multimedia player 15. Utilizing a menu the user can select the mode (GPS 14, Video, Audio, or Bright Onboard Display). Once the Bright Onboard Display mode is selected, there could be a preview function for programming purposes. The apparatus could be made in various sizes in order to fit different makes and models as it relates to the aftermarket product. An auto manufacturer can customize the control system 2 into their design plans. Or it could be sold as a standalone component with dash mount 5 as shown in FIG. 2.

FIG. 4 illustrates the Bright Onboard Display 1 installed in the rear window by the user. The Bright Onboard Display 1 can also be incorporated into the original equipment by auto manufacturer and positioned inside trunk lid or side panel of vehicle.

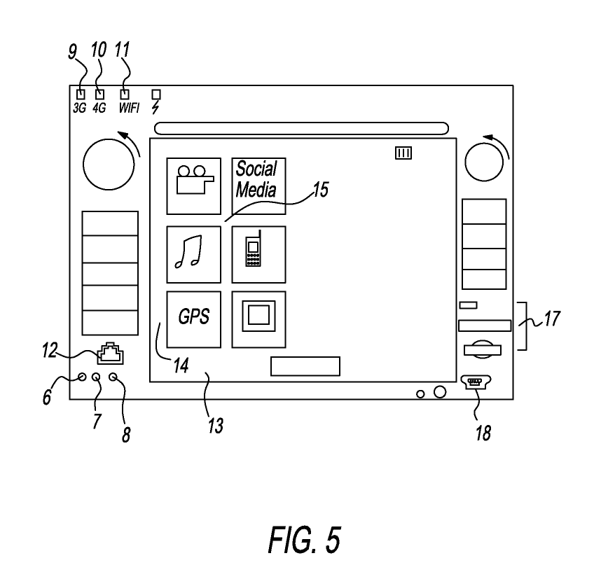

FIG. 5 illustrates the capabilities of an embodiment of the Bright Onboard Display control system 2. The apparatus may have an Ethernet jack 12 and/or wireless capabilities built in such as wifi 11, 3G 9, or/and 4G 10, giving it the capabilities to access the internet. The control system has a speech recognition system that recognizes voice commands that triggers corresponding preset messages to display on the onboard display. Moreover, the speech recognition system may convert voice message/phrase received through a microphone 4 (on the control system and/or the remote control or on a device coupled to the control system) to text, in real time, to display on the onboard display. This will allow a phrase to be entered in without pre-programming. A designated web site such as “BrightOnboardDisplay.com” or other social web site could provide a platform to send and receive messages. Moreover as a user sends a message to the Bright Onboard Display 1, it could simultaneously be sent to one or more email addresses or web sites. This allows the user simultaneous sharing message from vehicle to all the social media and currently existing messaging platforms (such as text, IM, SMS, fax-to-text, voice line with voice-to-text, and other platforms using electronic communications). The apparatus may utilize all of them to send or receive messages through Bright Onboard Display 1. An example is sending “accident near exit 10 on route 18 S” to the Bright Onboard Display 1 to notify the cars behind you and simultaneously have it sent to social websites and other currently existing messaging platforms to notify others about the accident.

By using the aforementioned communication technologies, many devices such as PC, Smartphone, ipad/tablet may be enabled to program and/or initiate messaging to display. Software applications (Apps) can be designed for these devices (for example, a smartphone can be used to program the display message) so they can be utilized as the primary or alternative programming devices. The control system 2 further comprising one or more means to transfer and backup data and settings. The means may include but not limited to multi-card reader 17, USB port 18 or the combination thereof.

Besides cars, the Bright OnBoard Display 1 and Control System 2 could also be used with bicycles and boats, etc.

This invention encompasses four basic messaging purposes.

1. Major Problem Notification—personal health or vehicle (e.g. Medical Problem—Call Ambulance, Engine trouble, Flat tire—help, etc.)

2. Traffic/Driving related communications (Left Turn Signal)—All Signals would trigger a corresponding text and/or graphic such as when the driver puts on left turn signal the Bright Onboard Display would use text “left turn” and/or a left blinking arrow.

3. Novelty (Hi Cutie) or (Happy Holidays)

4. Advertising (Bob's Tire Sale: buy 3 get 1 free 567-123-4567)

The following list includes Possible Preprogrammed Messages:

1. Merging right Please

2. Merge left Please

3. Caution

4. Help please

5. Help, need a phone

6. I am having a health problem

7. Please call the paramedics

8. Please follow me

9. Looking for address

10. Thank you

11. You're Welcome

12. Please

13. Please pull over

14. Sorry

15. Sorry, I screwed up

16. Stopping to eat

17. Stopping for gas

18. Please go around

19. Please drive in the slow lane

20. Please drive in the fast lane

21. Move ahead slow

22. Start turning left slowly

23. Start turning right slowly

24. Speed up

25. Move slowly

26. Please move back

27. Please move forward

28. Please slow down

29. Preparing to Stop

30. Something is wrong

31. Having a hard time seeing

32. Trying to find a parking space

33. Flat tire

34. Engine trouble

35. Vehicle is broken down

36. Cannot move Vehicle

37. Out of Gas

38. We will return soon

39. Please call a wrecker

40. Gone for a wrecker and mechanic

41. Please, you're driving to close

42. Your back tire is going flat

43. Your front tire is going flat

44. Please don't litter

45. Something looks wrong with your vehicle

46. Your car is dragging something

47. Your passengers are in danger

48. Your driving is dangerous

49. Accident ahead

50. You're cute

51. I'm single

52. What a bummer

53. My name is ______

54. My phone number is ______

55. I love my dog—wife—husband—university, surfing, FSU, MI, singing—etc

56. My child is an honor student

57. Just married

58. Go Dolphins, Bucks, Gators, Michigan, Panthers, Irish, etc Pro and Colleges

59. Patriotic messages; Support our troops, I love my country, USA, etc

60. Baby on board

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. An apparatus containing Bright Onboard Display and Control System, the apparatus comprising:
(a) An onboard display utilizing an illumination technology to display text messages and graphics;
(b) A control system coupled to the onboard display;
(c) The control system having wireless communication technologies to enable other devices to program and initiate messaging, the wireless communication technologies may include but not limited to RF, Bluetooth, IR, or the combination thereof;
(d) The control system having features allowing messages sent to the onboard display to be simultaneously sent to one or more email addresses, web sites or currently existing messaging platforms; and
(e) The control system having features to receive messages from web sites or currently existing messaging platforms, the message received may be sent to onboard display.
(f) The control system having a speech recognition system that recognizes voice commands that triggers corresponding preset messages to display on the onboard display.

2. The apparatus of claim 1, wherein the onboard display is LCD, LED, or other illumination technology.

3. The apparatus of claim 1, wherein the speech recognition system further having the capacity of recognizing and converting voice messages to text in real time to display on the onboard display.

4. The apparatus in claim 1, wherein the control system further equipped with the following technologies for multiple means of programming as well as message initiation: Bluetooth, IR, RF, 3G, 4G, Wifi, Wireless LAN, Ethernet Jack and USB port.

5. The apparatus in claim 1 further comprising a remote control with a setup menu incorporating numerous options, the remote control also having a microphone.

6. The apparatus of claim 1, wherein the control system further comprising a microphone.

7. The apparatus of claim 1, wherein the onboard display can be installed on or inside the vehicle.

8. The apparatus of claim 1, wherein the apparatus is aftermarket product, the device come with a touch screen and is a standalone component with dash mount.

9. The apparatus of claim 1, wherein the apparatus is incorporated into the original electronic system of the vehicle.

10. The apparatus of claim 8, wherein the control system is in the form of a touch screen interface built into the dash and is in conjunction with other electronic devices so that the user can select the mode (GPS, Audio, Video, or BrightOnboardDisplay).

11. The apparatus of claim 4, wherein the menu options in the remote control comprises: color of the message, personal information, set up option, animation speed, auto shutoff timer, and preset messages.

12. The apparatus of claim 1, wherein the features for allowing users to receive and send messages from web sites or currently existing messaging platforms may include but not limited to Ethernet jack, 3G, 4G, Wifi or the combination thereof.

13. The apparatus of claim 1, wherein the control systems further comprising one or more means to transfer and backup data and settings, the means may include but not limited to multi-card reader, USB port or the combination thereof.

14. The apparatus of claim 1, wherein the device is made in various sizes in order to fit different makes and models of vehicles as it relates to the aftermarket product. An auto manufacturer can customize the apparatus into their design plans.

15. The apparatus of claim 1, wherein the other devices may utilize software application (Apps) designed for them to become the primary or alternative programming devices; the other devices may include but not limited to PC, smartphone, ipad/tablet.

16. The apparatus of claim 12, wherein the preset messages include but not limited to four basic messaging purposes:
a) Major Problem Notification, e.g. personal health problems or vehicle problems
b) Traffic/Driving related communications
c) Novelty (Hi Cutie) or (Happy Holidays).
d) Advertising (Bob's Tire Sale: buy 3 get 1 free 567-123-4567)
